(19) United States
(12) Patent Application Publication
(10) Pub. No.: US 2010/0290574 A1
(43) Pub. Date: Nov. 18, 2010

(54) NEUTRON GENERATOR USING COMPRESSED FUSIBLE MATERIAL AND LASER PULSE

(76) Inventor: J. Stephen Hudgins, Blacksburg, VA (US)

Correspondence Address: STITES & HARBISON PLLC, 1199 NORTH FAIRFAX STREET, SUITE 900, ALEXANDRIA, VA, 22314, US

(21) Appl. No.: 12/464,377

(22) Filed: May 12, 2009

(51) Int. Cl. H05H 3/06

(52) U.S. Cl. 376/108

(57) ABSTRACT

To generate neutrons, a nuclei fusible material is placed between opposed anvils of a mechanical pressing device. Force is applied to an anvil face to compress the fusible material to a high pressure. A laser light pulse is then directed through the anvil face and into the compressed fusible material. This laser light pulse is focused by an optical system to a focal spot in the compressed fusible material, to cause a small portion of the compressed fusible material at the focal spot to be further locally compressed and heated to a temperature whereby a micro plasma is formed in which fusing of nuclei takes place. This fusion reaction of the nuclei in the fusible material thus generates neutrons. In a preferred embodiment, the mechanical pressing device is a diamond anvil, and the fusible material is one of deuterium, tritium, or a combination thereof.

### BACKGROUND OF THE INVENTION

Various devices have been constructed over the years to generate sources of neutrons which are no longer bound in the atomic nuclei. Sources of neutrons are used widely in medical, industrial and laboratory settings. Neutrons striking test materials can induce (via neutron activation) low levels of radioactivity in the material when the nuclei of the constituent elements absorb some of the neutrons which strike them. The particulars of the then reemitted neutrons and other particles allow remote nondestructive analysis of the material being tested.

Neutrons can be generated from various radioactive isotopes either by fissile isotopes which spontaneously emit neutrons or by isotopes which spontaneously produce alpha particles which can be used to produce neutrons after they are absorbed by certain intermediary elements. Radioisotopes which produce energetic gamma radiation via spontaneous decay can also be used to produce neutrons with the proper absorbing intermediary. All of these sources have the advantage that once constructed they continue to emit neutrons with no external input of energy over a lifetime determined by the radioisotope half life. Though simple to construct, these sources are highly regulated and require shielding to minimize their health risks since it is also a disadvantage that they continue to emit neutrons.

Neutrons can also be generated through the use of particle accelerators which accelerate charged nuclei of deuterium and/or tritium into other sources of deuterium and/or tritium nuclei or into deuterated or tritiated metal hydrides (as well as other appropriate fusible targets). Neutron sources which produce neutrons by ionizing and accelerating deuterium and/or tritium are electrically based devices, and thus these devices have the advantage that they can be turned on and off as needed. While deuterium is not naturally radioactive, tritium is naturally radioactive by beta emission, though the fairly small amounts of tritium involved in most applications and the relative ease of stopping beta emissions typically make the shielding and safety requirements much less onerous than for other radioactive sources.

One of the first devices of this accelerator type was the Fusor invented by television pioneer Philo Farnsworth. This device was initially conceived as a fusion power source, but when inherent inefficiencies in its design made this untenable as a power source it was resurrected as a neutron source. Many of the smaller neutron sources presently used in industry are miniature accelerators constructed in a sealed tube. A recent variant of this approach uses pyroelectric crystals to ionize deuterium and accelerate its nuclei into a deuterated target.

Energy, and more importantly, neutrons are emitted in such accelerator devices when the nuclei of deuterium and/or tritium are fused together to produce larger nuclei. Deuterium and tritium are not the only substances that can be fused, but they are easier than other elements to fuse. Because the nuclei of deuterium and/or tritium are positively charged however, and because positives repel other positives, a significant amount of energy is required to induce this fusion. But because these nuclei are charged, they can be manipulated by external electronic and magnetic fields which can be used to accelerate the nuclei to a high speed and in some way allow the nuclei to then impact other fusible species.

If the electrons surrounding the fusible atoms of deuterium and/or tritium are stripped and the material is brought to a plasma state, the elements will fuse if the plasma is sufficiently dense and hot. The temperature requirements are somewhat mitigated by the fact that, within any plasma at any average temperature there is a distribution of energies of the nuclei in a fairly regular fashion. In particular, this distribution is that some nuclei are significantly more energetic than the average, and these are the nuclei which would primarily be involved in the fusion process. High densities of the resulting plasma have been induced: a) by schemes which collapse the plasma, b) at shock interfaces of the plasma, or c) in inertial confinement techniques by extreme compression of deuterated and/or tritiated solids using an external laser beam or other external beam irradiation.

Lastly, nuclear reactors and high energy accelerators have been used as sources of neutrons.

### BRIEF SUMMARY OF THE INVENTION

In accordance with the present invention, a method and apparatus for generating neutrons is provided. Initially, a nuclei fusible material is placed between opposed anvils of a mechanical pressing device, with one anvil at least being made of a transparent material. Next, force is applied to an anvil face with the mechanical pressing device to compress the fusible material to a high pressure between the anvils. A laser light pulse is then directed through the anvil face and into the compressed fusible material. This laser light pulse is focused by an optical system to a focal spot in the compressed fusible material, to cause a small portion of the compressed fusible material at the focal spot to be further locally compressed and heated to a temperature whereby a micro plasma is formed in which fusing of nuclei takes place. This fusion reaction of the nuclei in the fusible material thus generates neutrons.

In a preferred embodiment, the mechanical pressing device is a diamond anvil, and the transparent face is a facet of a diamond of the diamond anvil.

Also in a preferred embodiment, the fusible material is one of deuterium, tritium, or a combination thereof.

Further in one preferred embodiment, a preferred laser pulse is that produced by a Nd—YAG laser.

Still further in a preferred embodiment, the fusible material is compressed to a pressure in excess of 100 gigapascals, and this compressed fusible material is further locally compressed and heated by the laser pulse to a temperature in excess of 10,000° K.

In order to produce a series of pulses of neutrons in accordance with the present invention, the optical system includes a positioning mechanism for moving the focal point to different spots in the fusible material. Thus, multiple pulses of the laser are used to produce multiple pulses of neutrons.

It is an advantage of the present invention that a pulse of neutrons can be produced when desired.

It is also an advantage of the present invention that a neutron generator is provided which does not need any significant radiation shielding when not in use.

Other features and advantages of the present invention are stated in or apparent from detailed descriptions of presently preferred embodiments of the invention found hereafter.

### BRIEF DESCRIPTION OF THE SEVERAL VIEWS OF THE DRAWINGS

FIG. 1 is a schematic representation of a diamond anvil mechanical pressing device used in the present invention.

FIG. 2 is a schematic representation of a neutron generating device of the present invention using the pressing device of FIG. 1.

### DETAILED DESCRIPTION OF THE INVENTION

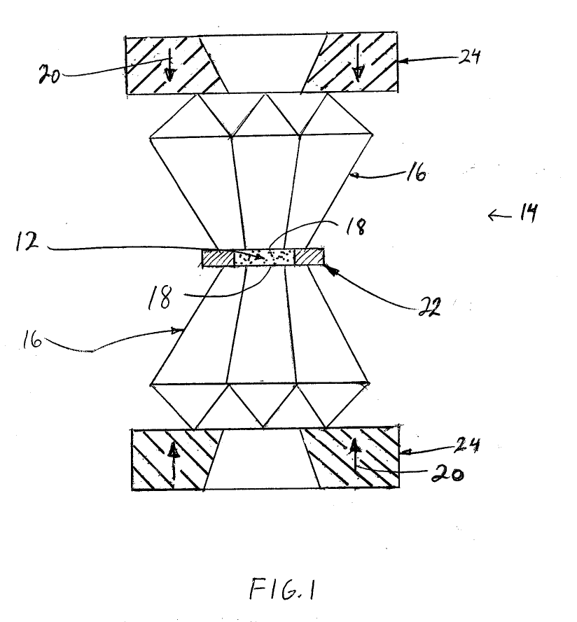

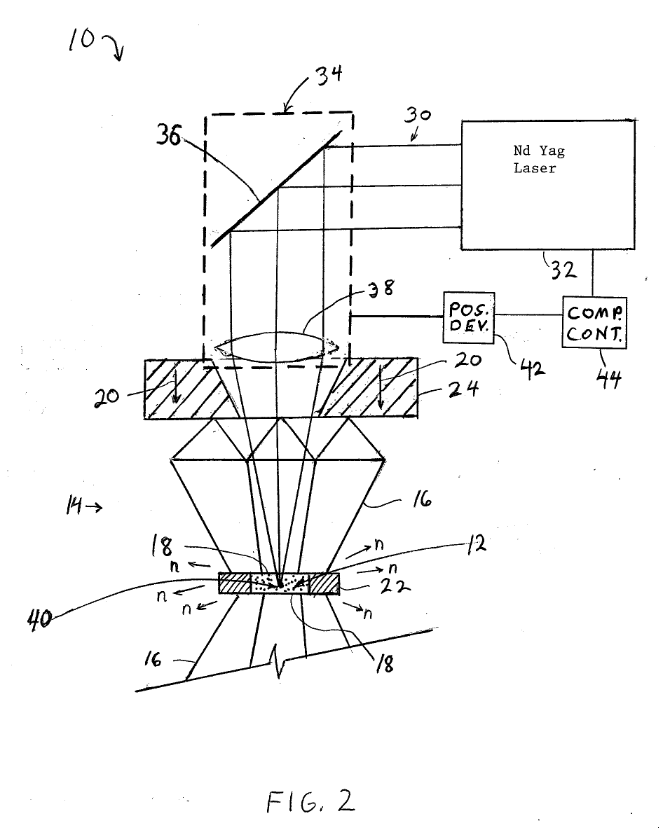

With reference now to the drawings in which like numerals represent like elements throughout the views, a neutron generating apparatus 10 for generating neutrons is depicted in FIGS. 1 and 2. Apparatus 10 uses a mechanical means to compress a nuclei fusible material 12, preferably a deuterated and/or tritiated (or other species) substrate since such substrates readily and predictably produce neutrons when fusion occurs. In addition, such a fusible material 12 is preferred since tritium decays only by beta emission, which is easily shielded (compared with gamma sources used in the prior art for generating neutrons as noted above), and it has a satisfactory half-life of about 12.5 years.

One suitable mechanical means, though certainly not the only possible means as will be appreciated by those of ordinary skill in the art, for generating the extreme pressures which are required for the functioning of the present invention is a mechanical pressing device 14 as schematically depicted in FIG. 1. Mechanical pressing device 14 provides two diamonds 16 with parallel flattened faces or bases 18 in mechanical opposition to one another as shown. Then, by use of a mechanical, hydraulic or other suitable driving means as illustrated by arrows 20, faces 18 are brought toward each other generating extreme levels of pressure on any material placed between these two faces 18. One well-known commercial manifestation of this type of device is a diamond anvil cell. Using this type of device, pressures of several hundred gigapascals (tens of millions of pounds per square inch) can be applied to a material being compressed thereby. Diamonds 16 are used because of their extreme hardness, and diamonds 16 have the further advantage for the present invention of being transparent. In the prior art, this transparency of diamonds 16 has the advantage of allowing visualization of the testing of the material being compressed. As illustrated, diamond anvil pressing device 14 provides a test volume in which fusible material 12 is located, and this test volume is surrounded by a gasket 22 placed between the two diamonds 16 and their associated support structures 24. Gases, liquids and solids are all compressible in diamond anvil pressing device 14 as known in the art.

Mechanical pressing device 14, contrary to its typical use in the prior art to compress a simple test material, is now used initially to compress fusible material 12. Fusible material 12 can be a solid, liquid or gaseous form of deuterium, tritium or other fusible material (or mixture of these materials) as desired. Fusible material is thus placed in the volume between the opposing faces or facets 18 of diamonds 16 in pressing device 14. Then, after fusible material 12 is brought up to a desired and predetermined pressure in pressing device 14, a pulse of focusable laser light, such as a pulse 30 of laser light from a neodymium YAG laser 32, is directed in a converging path through one of diamond faces 18 as shown in FIG. 2.

While lasers, including YAG lasers 32, have been used with diamond anvil cells in the prior art, they were typically used only to heat the substance being tested. In accordance with the present invention, instead of generalizing heating of the specimen, pulse 30 of YAG laser 32 is brought to a sufficiently fine focal point 40 by an optical system 34. Optical system 34 in this schematic representation includes a mirror 36 and a lens 38. At focal point 40, photodisruption occurs on a microscopic level leading to the ablation or intense heating of a microscopic amount or portion of fusible material 12 thereat. This tiny spot heating results in a localized micro plasma of fusible material 12 which has a fairly high temperature (10,000 to 20,000° K.), and which micro plasma also tries to expand inducing localized compression superimposed on the compressive pressure already exerted on the surrounding fusible material 12. Due to the pressure, shock effects and temperature in the produced micro plasma, some fraction of the nuclei in the localized micro plasma are sufficiently energetic to fuse with other nuclei therein. This fusion of the nuclei, as well known in the art, releases neutrons n of characteristic energy depending on the fusing species of nuclei.

In other words, pulse 32 of laser light results in energy densities high enough to create a microscopic point of photodisruption at focal point 40 representing a tiny localized or micro plasma. Temperature and shock effects at focal spot 40 superimposed on the static pressure created by anvil pressing device 14 lead to fusing of nuclei in a small portion of fusible material 12 in the micro plasma at focal spot 40. This fusion reaction of the nuclei in fusible material 12 thus generates a pulse of neutrons.

Because laser pulse 30 is focused to a small point and diverges beyond its point of focus 40, photodisruption only occurs at or very near the exact point of focus. Thus, as the production of neutrons n depends on the number of fusion events that occur within the brief lifespan of the micro plasma induced by laser pulse 30, the generation of neutrons n is not continuous, but rather neutrons n are released as a short pulse. However, as known in the art, focal point 40 is easily manipulated using a suitable positioning device 42 which can control optical system 34 appropriately (typically mirror 36 or the like), often to an accuracy of hundredths of a millimeter for focal point 40. Thus, by use of positioning device 42 and a simple computer control 44 or the like for actuating positioning device 42 and laser 32 as many times as are needed, multiple laser pulses 30 and resultant micro plasmas are generated in close temporal proximity to one another in fusible material 12 so as to generate a series of pulses of neutrons. The amount of fusible material 12 ionized and therefore the amount of micro plasmas generated would be limited only by the amount of laser pulse energy that could introduced into the volume under the extreme compression without adversely affecting the integrity of pressing device 14 itself.

It is noted that it is unlikely that temperatures and densities would be the same throughout the micro plasma in fusible material 12. Pressures and densities would likely be lower in some regions and higher in others. However, this simply means that in areas of the micro plasma where temperatures and pressures were locally higher, these areas would likely account for more or most of the neutron n production.

While use of a modified diamond anvil cell to compress fusible material 12 has been particularly described above, it will be appreciated by those of ordinary skill in the art that other mechanical methods not necessarily using diamonds would be feasible. Likewise, while use of a Nd—YAG laser 32 has been described, other lasers which can achieve the energy densities necessary for creation of a micro plasma could alternatively be employed.

Thus, while the present invention has been described with respect to an exemplary embodiment thereof, it will be understood by those of ordinary skill in the art that variations and modifications can be effected within the scope and spirit of the invention.

I claim:

1. A method for generating neutrons comprising the steps of:
placing a nuclei fusible material between opposed anvils of a mechanical pressing device;
applying force to an anvil face with the mechanical pressing device to compress the fusible material to a high pressure; and
fusing a small portion of the fusible material to generate neutrons, said fusing step including the steps of
directing a laser light pulse through the anvil face and into the compressed fusible material, and
focusing the laser light pulse to a focal spot in the compressed fusible material to cause a small portion of the compressed fusible material at the focal spot to be further locally compressed and heated to a temperature whereby a micro plasma is formed in which fusing of nuclei takes place, which fusing of nuclei in the fusible material generates neutrons.

2. A method for generating neutrons as claimed in claim 1, wherein said applying step includes the step of applying force to a diamond anvil face of a diamond anvil pressing device, and said directing step includes the step of transmitting the laser light pulse through the diamond anvil face.

3. A method for generating neutrons as claimed in claim 1, wherein said applying step compresses the fusible material to a pressure in excess of 100 gigapascals, and said focusing step heats the micro plasma to a temperature in excess of 10,000° K.

4. A method for generating neutrons as claimed in claim 1, wherein the fusible material is one of deuterium, tritium, or a combination thereof.

5. A method for generating neutrons as claimed in claim 1, wherein said fusing step is repeated in quick succession with said focusing step focusing the laser light pulse to a different small portion of the compressed fusible material with each repeated fusing step so that a series of micro plasmas are formed and corresponding pulses of neutrons are generated.

6. A neutron generating device comprising:
a nuclei fusible material;
a mechanical pressing device which compresses said fusible material to a high pressure, said mechanical device including a light transparent face which presses said fusible material against an opposite parallel face;
a laser which produces a laser light pulse;
an optical system which focuses the laser pulse through said transparent face and to a focal point in the pressed fusible material such that the combination of pressurization of the fusible material by said pressing device and further localized compressing and heating of the pressed fusible material from the laser pulse causes the fusible material at the focal point to form a micro plasma in which fusion takes place, which fusion produces a pulse of neutrons.

7. A neutron generating device as claimed in claim 6, wherein said mechanical pressing device is a diamond anvil, and wherein said transparent face is a facet of a diamond of said diamond anvil.

8. A neutron generating device as claimed in claim 6, wherein said fusible material is one of deuterium, tritium, or a combination thereof.

9. A neutron generating device as claimed in claim 6, wherein said laser is a Nd—YAG laser.

10. A neutron generating device as claimed in claim 6, wherein said optical system includes a positioning mechanism for moving the focal point to different spots in said fusible material so that multiple micro plasmas are formed and corresponding pulses of neutrons are produced.

11. A neutron generating device as claimed in claim 6, wherein said pressing device presses said fusible material to a pressure in excess of 100 gigapascals, and said laser further locally compresses and heats said pressed fusible material to the micro plasma with a temperature in excess of 10,000° K.

12. A neutron generating device comprising:
a nuclei fusible material which is one of deuterium, tritium, or a combination thereof;
a diamond anvil pressing device which compresses said fusible material to a high pressure in excess of 100 gigapascals, said pressing device including a light transparent face which presses said fusible material against an opposite parallel face;
a laser which produces a laser light pulse;
an optical system which focuses the laser pulse through said transparent face and to a focal point in the pressed fusible material such that the combination of pressurization of the fusible material by said pressing device and further localized pressing and heating of the pressed fusible material from the laser pulse to a temperature in excess of 10,000° K. causes the fusible material at the focal point to form a micro plasma in which fusion takes place, which fusion produces a pulse of neutrons.

13. A neutron generating device as claimed in claim 12, wherein said optical system includes a positioning mechanism for moving the focal point to different spots in said fusible material so that multiple micro plasmas are formed and corresponding pulses of neutrons are produced.
